(19) United States
(12) Patent Application Publication
(10) Pub. No.: US 2015/0158748 A1
(43) Pub. Date: Jun. 11, 2015

(54) PROCESS FOR TREATING CONCENTRATED BRINE

(71) Applicant: Pall Filtration Pte. Ltd., East Wing (SG)

(72) Inventor: Ramkumar KARLAPUDI, Singapore (SG)

(21) Appl. No.: 14/100,170

(22) Filed: Dec. 9, 2013

(51) Int. Cl. C02F 1/52; C02F 1/44

(52) U.S. Cl. CPC C02F 1/52; C02F 1/44

(57) ABSTRACT

Processes and systems for treating concentrated brine are disclosed. One process comprises mixing a first concentrated brine containing silica with one or more silica-precipitating agents in a mixer and producing a first fluid comprising a first concentrated brine and precipitates of silica, passing the first fluid through a first filter device comprising a microfiltration or ultrafiltration membrane such that precipitates of silica are retained by the membrane and a silica precipitate-depleted fluid passes through the membrane and through an inlet of a second filter device comprising a housing comprising an inlet, a first outlet and a second outlet, a first fluid flow path defined between the inlet and first outlet, and a second fluid flow path defined between the inlet and the second outlet, a reverse osmosis membrane having an upstream surface and a downstream surface positioned within the housing across the first fluid flow path. The silica precipitate-depleted fluid passes tangentially to the upstream surface of the membrane such that permeate is passed along the first fluid flow path through the membrane and through the first outlet, and a second concentrated brine is passed tangentially to the upstream surface of the membrane and through the second outlet.

### BACKGROUND OF THE INVENTION

The treatment of brine often involves a number of treatment technologies (such as, e.g., membrane, distillation, clarification) to recover a reusable clean liquid and concentrated brine that must be disposed. However, due to the elevated salt concentrations of the concentrated brine, its disposal presents significant costs and challenges for many industries.

Several methods can be used to dispose of concentrated brine. Discharging the concentrated brine into the sea is one approach, but this method can an environmental challenge since the concentrated brine will tend to accumulate at the sea bottom and have an adverse effect on bottom dwelling organisms. Another approach is to transport the concentrated brine to evaporation ponds where the liquid portion is removed by evaporation. However, this is an extremely expensive solution since evaporation ponds require a significant amount of land, labor and materials and evaporation is very slow in many climates which limit the rates at which the solids can be removed to a landfill. Deep well disposal is another approach, but due to its capital costs and the possibility of groundwater contamination, its use has been limited to very specific applications.

With the mounting concern over disposal problems and the impact of long-term storage of concentrated brines, government agencies around the world have implemented zero liquid discharge (ZLD) regulations. Under these regulations, operating facilities are required to treat the concentrated brine to recover a highly concentrated liquid or a dry solid having essentially little or no liquid (e.g., salt cake). Conventional methods for treating concentrated brine (such as, e.g., the use of vapor recompression systems, forced circulation evaporators, crystallizers and spray driers) have been widely accepted and applied within treatment plants to achieve ZLD. However, these techniques are very expensive in terms of capital and operating costs and often result in high energy consumption.

Accordingly, there is a continued need for a method for treating concentrated brine.

### BRIEF SUMMARY OF THE INVENTION

In accordance with one aspect of the invention, a process for treating concentrated brine comprises mixing a first concentrated brine, containing silica, with one or more silica-precipitating agents and producing a first fluid containing a first concentrated brine and precipitates of silica; passing the first fluid through the inlet of a first filter device comprising a housing comprising an inlet, one or more outlets, one or more fluid flow paths defined between the inlet and the one or more outlets, a microfiltration or ultrafiltration membrane positioned within the housing across the one or more fluid flow paths; passing the first fluid through the membrane, retaining the precipitates of silica by the membrane and passing a silica precipitate-depleted fluid, which passes through the membrane, through the one or more outlets through the inlet of a second filter device comprising a housing comprising an inlet, a first outlet and a second outlet, a first fluid flow path defined between the inlet and first outlet, and a second fluid flow path defined between the inlet and the second outlet, a reverse osmosis membrane having an upstream surface and a downstream surface positioned within the housing across the first fluid flow path; passing the silica-precipitate-depleted fluid tangentially to the upstream surface of the membrane; passing a permeate along the first fluid flow path through the membrane and through the first outlet, and passing a second concentrated brine tangentially to the upstream surface of the membrane and along the second fluid flow path and through the second outlet. One embodiment of the process further includes holding the mixture prior to producing a first fluid. In another embodiment, the silica precipitate-depleted fluid is passed through a high-pressure reverse osmosis filter device.

Another aspect of the invention is directed to a system for treating concentrated brine. In one embodiment, the system includes a mixer comprising one or more inlets for passing a first concentrated brine, containing silica, and one or more silica-precipitating agents into the mixer, and an outlet. In another embodiment, the system includes a fluid input arrangement including one or more inlets, an outlet and an interior passageway. The system further includes a first filter device. In one embodiment, the first filter device is in fluid communication with the mixer and, in another embodiment, the first filter device is in fluid communication with the fluid input arrangement. The first filter device includes a housing comprising an inlet, one or more outlets, one or more fluid flow paths defined between the inlet and the one or more outlets, and a microfiltration or ultrafiltration membrane positioned within the housing across the one or more fluid flow paths. The system further includes a second filter device in fluid communication with the first filter device. The second filter device includes a housing comprising an inlet, a first outlet and a second outlet, a first fluid flow path defined between the inlet and first outlet, and a second fluid flow path defined between the inlet and the second outlet, a reverse osmosis membrane having an upstream surface and a downstream surface positioned within the housing across the first fluid flow. In many of the embodiments, the system includes a holding tank. For example, in various embodiments, the system includes a holding tank, which has a holding tank inlet in fluid communication with the outlet of the mixer and/or fluid input arrangement and a holding tank outlet in fluid communication with the inlet of the first filter device. In one or more of the embodiments, the second filter device is a high-pressure reverse osmosis filter device.

Another aspect of the invention is directed to a ZLD plant. In one embodiment, the plant includes the system for treating concentrated brine and an evaporator.

### BRIEF DESCRIPTION OF THE SEVERAL VIEWS OF THE DRAWING(S)

FIG. 1 is a representative schematic view, not to scale, of one embodiment of a system for treating concentrated brine.

FIG. 2 is a representative schematic view, not to scale, of another embodiment of a system for treating concentrated brine.

### DETAILED DESCRIPTION OF THE INVENTION

Embodiments of the present invention provide many advantages. For example, the process and system, in accordance with one or more embodiments, may result in improved treatment processes and reduced energy consumption and may reduce the need for downstream treatment steps, such as, e.g., the use of evaporation ponds or larger-sized evaporators. Advantageously, as exemplified by one or more embodiments, by removing or substantially reducing the concentration of silica from the first concentrated brine, a higher percentage of the concentrated brine may be recovered, which may be particularly advantageous in facilities or processing plants that fall under jurisdictions having very stringent waste discharge regulations, such as, e.g., ZLD regulations.

The following definitions are used in accordance with the invention.

“Brine” is defined as wastewater having salt and a silica concentration of less than 50 ppm.

“Concentrated brine” is defined as brine which has a silica concentration of at least 50 ppm and a concentration of salt that is, by a factor of greater than 1, greater than the salt concentration of brine.

“Salt” is defined as dissolved ions of any ionic compounds present in the wastewater. Common salts may include halide salts such as alkali metal halides (e.g., sodium chloride, potassium chloride, etc.) and alkali earth metal halides (e.g., magnesium chloride, calcium chloride, etc.). Salts may also include the salts of polyatomic cations and anions, such as ammonium salts, phosphate salts, nitrate salts, sulfate salts, and oxyhalide salts, among other kinds of salts.

As used herein, the term, “wastewater”, has its conventional meaning in the field and includes water produced from a variety of processes including, without limitation, food processing, municipal water treatment, cooling tower blow-down, pulp and paper manufacturing and processing, chemical manufacturing and processing, manufacturing and processing of pharmaceuticals, mining, refinery effluent, rinse water, produced water, and a variety of other industrial activities.

The following descriptions are intended to illustrate various embodiments of the invention. As such, the specific modifications discussed are not to be construed as limitations on the scope of the invention. It will be apparent to one skilled in the art that various equivalents, changes, and modifications may be made without departing from the scope of the invention, and it is understood that such equivalent embodiments are to be included herein.

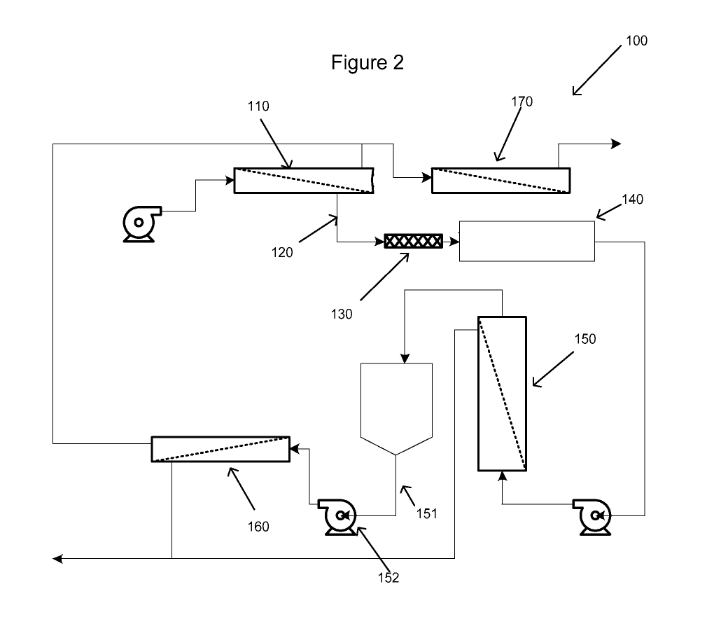

An embodiment of the present invention relates to a process for treating concentrated brine. The concentrated brine (i.e., the first concentrated brine) may originate from a variety of sources, but it generally includes brine which has been processed and concentrated through one or more of a variety of upstream wastewater treatment processes (such as, e.g., the combination of one or more micro- or ultra-filtration units and one or more concentrators, nano-filtration devices or reverse osmosis units). For example, in at least one embodiment, as illustrated in FIG. 2, the source of the first concentrated brine is obtained by passing at least some portion of brine through reverse osmosis unit 110, to produce a first concentrated brine, which is then treated in accordance with one or more embodiments of the present invention.

The precise composition and concentration of the first concentrated brine in accordance with one or more embodiments of the present invention may vary depending upon the nature of the wastewater to be treated and the wastewater treatment processes. However, in the embodiments, the first concentrated brine includes at least 50 ppm of silica and, optionally, one or more of a variety of dissolved impurities (such as, e.g., magnesium, carbonate, calcium, sulfates, etc.).

The type of silica-precipitating agent to be mixed with the first concentrated brine may vary depending upon a variety of operational conditions (such as, e.g., pressure, temperature, the nature of the first concentrated brine, the nature of the silica to be removed, concentrations of any one or more of the constituents of the brine, etc.), but any of a variety of materials that can accelerate the precipitation (or flocculation or coagulation) of silica, function as a reaction product to form a precipitate (or floc or coagulate) of silica, function as adsorption sites or seed crystals onto which silica is precipitated, and/or form agglomerates of silica can be used. The term “precipitating”, as used herein refers has its conventional meaning in the field, but the term can also be used to mean flocculating, coagulating or agglomerating. In one embodiment, one silica-precipitating agent is used to form precipitates of silica. In another embodiment of the present invention, one silica-precipitating agent is used to precipitate (e.g., insolubilize) dissolved silica in the first concentrated brine and another silica-precipitating agent is used to bring these precipitates together (i.e., agglomerate) to form agglomerates of silica precipitates. Exemplary silica-precipitating agents include, without limitation, aluminum salts, sodium aluminate, aluminum chloride, aluminum hydroxide, aluminum sulfate, manganese chloride, manganese hydroxide, manganese oxide, polyaluminum chloride, polyaluminum sulfate, iron salts, magnesium oxide, ferric chloride, ferric sulfate, organic precipitating agents, aluminum rich chemicals, flocculants and/or coagulants, such as, e.g., polyacrylamides, polydiallydimethylammonium chlorides, any agglomerating agents, and the like.

The amount of silica-precipitating agent to be used, in accordance with an embodiment of the present invention, will vary depending, in part, upon the amount of silica present in the first concentrated brine. For example, in one embodiment, the silica-precipitating agent to silica ratio is about 0.5:1 and, in another embodiment, the ratio is about 2.5:1. In one or more embodiments, the amount of silica-precipitating agent can range between about 0.5 ppm or more, or at least about 2.5 ppm, or at least about 5 ppm, or at least about 10 ppm, or at least about 50 ppm up to about 300 ppm.

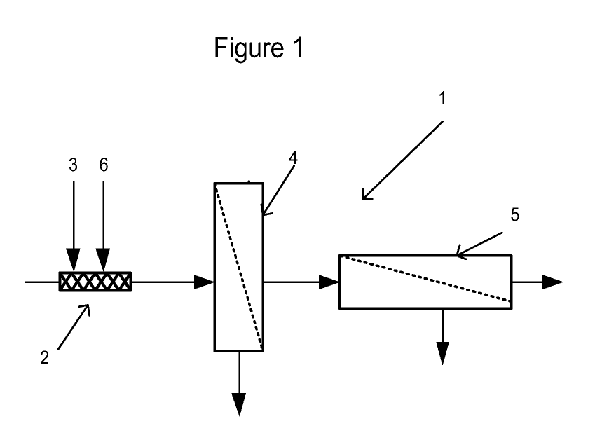

The silica-precipitating agents and the first concentrated brine may be mixed according to any suitable method known to those skilled in the art (including, without limitation, stirring, shaking, vibrating, bubbling, spraying, etc.). For example, in one embodiment, as illustrated in FIG. 1, the first concentrated brine and the one or more silica-precipitating agents are mixed by adding one or more silica-precipitating agents into a fluid input arrangement containing the first concentrated brine. In another embodiment, as illustrated in FIG. 2, the mixing is facilitated by introducing (i.e., adding) the first concentrated brine and the one or more silica-precipitating agents into a mixer.

The first concentrated brine and the one or more silica-precipitating agents may be added to the fluid input arrangement in a variety of ways. For example, as illustrated in the embodiment shown in FIG. 1, the one or more silica-precipitating agents are injected into fluid input arrangement 2, through which the first concentrated brine passes, through injection point 3.

The first concentrated brine and one or more silica-precipitating agents may be added to the mixer in a variety of ways. For example, the first concentrated brine and the one or more silica-precipitating agents may be combined (i.e., mixed) prior to being supplied to the mixer. For example, in the embodiment illustrated in FIG. 2, the one or more silica-precipitating agents are added into fluid input arrangement 120, which contains first concentrated brine passing therethrough, to produce a mixture and the mixture is added to mixer 130 for further mixing.

The one or more silica-precipitating agents and the first concentrated brine may also be supplied separately, sequentially, or simultaneously, into the mixer through separate ports or through a common port. Preferably, the one or more silica-precipitating agents may be introduced in a liquid or solid state.

The first concentrated brine and the one or more silica-precipitating agents may be mixed under a variety of one or more suitable conditions. Suitable conditions will depend upon any of a variety of operational conditions, and are readily discernible by those skilled in the art. Typically, suitable conditions may include, without limitation, temperature, pressure, the type of mixing provided between the one or more silica-precipitating agents and the first concentrated brine, the mixing rates, the type of silica-precipitating agents, the nature of the contaminant to be removed, etc. The first concentrated brine and the one or more silica-precipitating agents may be mixed for a period of time sufficient to produce a first fluid including the first concentrated brine and precipitates of silica. The amount of time required to generate the silica precipitates is dependent upon any one or more of a variety of factors, including, without limitation, the nature of the silica to be formed, the type of silica-precipitating agent(s) selected, the pH of the first concentrated brine, the nature of the salt present in the first concentrated brine, the type of mixing, and other factors known to those skilled in the art. The amount of mixing time necessary to generate a first fluid including the first concentrated brine and silica precipitates is generally more than about 1 minute, or between about 1 minute and about 12 hours, or between about 5 minutes and about 1 hour. In one embodiment, the first concentrated brine and the one or more silica-precipitating agents are mixed for between about 1 minute and about 20 minutes.

Adjusting the pH of the first concentrated brine can accelerate the production of silica precipitates in the brine. Without intending to be held to any particular theory, by adjusting the pH of the first concentrated brine, it is believed possible to modify or condition the charge of silica in such a way that it is more attractive to the silica-precipitating agents. Thus, as a further aspect of the present invention, the process for treating concentrated brine may also include adjusting the pH of the first concentrated brine prior to mixing the one or more silica-precipitating agents and the first concentrated brine. For example, in one embodiment, the pH of the first concentrated brine is adjusted prior to mixing the one or more silica-precipitating agents and the first concentrated brine. The pH adjustment may depend upon a variety of one or more conditions including, e.g., the ionic characteristics of the first concentrated brine and the type of the one or more silica-precipitating agents. The pH may be adjusted to a higher pH or may be adjusted to a lower pH. The pH may be raised to a variety of suitable pH levels. For example, the pH of the first concentrated brine may be raised from between about 0.5 and about 2 pH units. In one embodiment, the pH of the first concentrated brine is raised between about 1 and about 2 pH units. The pH may be lowered to a variety of pH levels. For example, the pH of the first concentrated brine may be lowered from between about 0.5 and about 2 pH units. In one embodiment, the pH of the first concentrated brine is lowered between about 1 and about 2 pH units.

In one embodiment, raising or lowering the pH of the first concentrated brine further comprises adding a pH adjuster to the first concentrated brine. The pH adjuster may be added to the first concentrated brine in varying amounts depending upon the process conditions. The pH adjuster may be added to the first concentrated brine in a variety of ways, such as, e.g., adding the pH adjuster to the first concentrated brine at one or more points, such as, e.g., injection points. In an exemplary embodiment, as shown in FIG. 1, the pH adjuster is injected into a fluid input arrangement 2 including the first concentrated brine via injector 6. The pH adjuster and first concentrated brine may also be supplied separately, sequentially or simultaneously into the fluid input arrangement through separate ports or through a common port. The pH adjuster may be introduced in a liquid or solid state. Exemplary pH adjusters include bases and acids. Exemplary acids include, without limitation, sulfuric acid, hydrochloric acid, nitric acid, citric acid; and exemplary bases include, without limitation, sodium hydroxide, sodium carbonate, calcium carbonate, calcium oxide, calcium hydroxide, potassium hydroxide. Any other suitable pH adjuster may also be used to adjust the pH of the first concentrated brine.

The first concentrated brine and the one or more silica-precipitating agents may be mixed under suitable temperatures and/or pressures. Without intending to be bound by any particular theory, when the pressures and/or temperatures of the first concentrated brine are within a suitable range, it is believed that the chemical equilibrium of the first concentrated brine may be disturbed and the saturation of, e.g., silica (and possibly one or more dissolved impurities) is exceeded, thereby causing the silica to form precipitates. Temperatures and/or pressures may vary depending upon a variety of factors, but they should be sufficient to produce precipitates of silica in the first concentrated brine.

After the one or more silica-precipitating agents and the first concentrated brine have been mixed, the mixture may be held to produce a first fluid including a first concentrated brine and precipitates of silica. It is believed that by increasing contact time between the one or more silica-precipitating agents and the first concentrated brine, the extent of the reaction between the agents and the silica improves, thereby increasing the formation of silica precipitates. The mixture may be held in any one or more of a variety of ways. For example, the one or more silica-precipitating agents may be mixed with the first concentrated brine in, e.g., a fluid input arrangement or mixer, and held within the fluid input arrangement or mixer. In another example, the one or more silica-precipitating agents may be mixed with the first concentrated brine in, e.g., a fluid input arrangement and/or a mixer, and passed from the fluid input arrangement and/or mixer to, e.g., holding tank. In yet another example, the one or more silica-precipitating agents may be mixed with the first concentrated brine in a fluid input arrangement, passed to a mixer for further mixing and then passed to a holding tank, wherein the mixture is held to produce a first fluid including a first concentrated brine and precipitates of silica. For example, in one embodiment, as shown in FIG. 2, the first concentrated brine and one or more silica-precipitating agents are mixed in fluid input arrangement 120, passed to mixer 130, and the mixture is passed to a holding tank 140. Other combinations or arrangements such as, e.g., additional mixers, holding tanks, receptacles, fluid lines, etc., may also be employed provided the combination or arrangement helps facilitate the formation of silica precipitates in the first concentrated brine. The holding times may depend upon a variety of one or more conditions including, e.g., the nature of the silica, the contents of the first concentrated brine, the amount of the silica-precipitating agents, temperatures, pressures, etc., but they are generally between about 1 minute to about 30 minutes, or about 5 minutes to about 20 minutes.

After the one or more compounds and the first concentrated brine have been mixed and, in at least one embodiment, held, a first fluid including a first concentrated brine and precipitates of silica is produced. The precipitates may be suspended in the first concentrated brine or may, e.g., precipitate and settle out of the first concentrated brine. The size of the precipitates may vary depending upon a variety of one or more conditions, such as, e.g., mixing rates, contact times, etc., but according to any one or more embodiments, the size of the precipitates are from about 0.1 microns or greater, or about 1 micron to about 10 microns. Advantageously, in one embodiment, the size of the precipitates of silica is about 0.5 microns to about 5 microns. In yet another embodiment, precipitates of a smaller size (such as, e.g., 0.5 microns) are initially formed and agglomerated together to form agglomerates of the silica precipitates having a larger size (such as, e.g., 5 microns or more).

After a first fluid including the first concentrated brine and precipitates of silica is produced, the precipitates may be separated from the first concentrated brine through a first filter device to produce a silica precipitate-depleted fluid. The precipitates of silica may be passed from one component, such as, e.g., a mixer, fluid input arrangement, or holding tank, to the first filter device in a variety of ways. For example, in the illustrated embodiment of FIG. 1, the first fluid is passed from fluid input arrangement 2 and supplied to the first filter device 4. In another embodiment, as shown in FIG. 2, the first fluid is passed from holding tank 140 and supplied to the first filter device 150. The first fluid may be supplied to the first filter device at a variety of flow rates and pressures, depending upon the type of first filter device used and the amount of first concentrated brine and silica precipitates to be processed.

The first fluid may be supplied to a first filter device which includes a housing having an inlet, one or more outlets, one or more fluid flow paths defined between the inlet and the outlet, a microfiltration or ultrafiltration membrane positioned within the housing across the one or more fluid flow paths. Within the first filter device, according to this embodiment, as the first fluid passes through the membrane, the precipitates of silica are retained by the membrane and the silica precipitate-depleted fluid passes through the membrane through the one or more outlets.

The composition of the silica precipitate-depleted fluid may vary depending upon a variety of processing conditions, but its salt concentration will generally be the same, or substantially the same, as the concentration in the first concentrated brine and, depending upon the holding times and dosage rates of the silica-precipitating agents, its silica concentration may be in the range of about 30% to about 100% of the silica concentration of the first concentrated brine. In one embodiment, the silica concentration in the silica precipitate-depleted fluid is in the range of about 95% to about 100% of the silica concentration of the first concentrated brine.

After the silica precipitate-depleted fluid is produced in the first filter device, the silica precipitate-depleted fluid may be passed to a second filter device to be concentrated. The silica precipitate-depleted fluid may be passed from the first filter device to the second filter device either directly or indirectly through one or more additional components, such as, e.g., one or more fluid input arrangements, containers, etc. In one illustrative embodiment, as shown in FIG. 1, the silica precipitate-depleted fluid is passed from the first filter device 4 via an outlet of the first filter device 4 and supplied to the second filter device 5 into the inlet of the second filter device 5. In another illustrative embodiment, as shown in FIG. 2, the silica precipitate-depleted fluid is passed from first filter device 150 and supplied to the second filter device 160, via a fluid input arrangement 151 and pump 152.

The silica precipitate-depleted fluid may be passed through a second filter device which includes a housing including an inlet, a first outlet, and a second outlet, a first flow path defined between the inlet and first outlet, and a second flow path defined between the inlet and the second outlet, a reverse osmosis membrane having an upstream surface and a downstream surface positioned in the housing across the first fluid flow path. Within the second filter device, according to this embodiment, the silica precipitate-depleted fluid is passed tangentially to the upstream surface of the membrane, a permeate is passed passes along the first flow path through the membrane and through the first outlet, and a second concentrated brine is passed tangentially to the upstream surface of the membrane and along the second flow path through the second outlet.

For many embodiments, passing the silica precipitate-depleted fluid through a second filter device may include passing the silica precipitate-depleted fluid through a high-pressure reverse osmosis filter device.

The silica precipitate-depleted fluid may be passed through the second filter device in accordance with one or more of a variety of different operational conditions, such as, e.g., osmotic pressure of the first concentrated brine. Normally, the recovery or production of the second concentrated brine through the second filter device is limited by the osmotic pressure of the first concentrated brine. Therefore, as long as the pressures across the second filter device is high enough to overcome the osmotic pressure of the first concentrated brine, the first concentrated brine may be subjected to any suitable operating pressure to cause the silica precipitate-depleted fluid to pass through the second filter device. Typically, the second filter device (such as, e.g., spirally-wound low pressure filters, e.g., spirally-wound low pressure reverse osmosis filters) can be operated at lower pressures (i.e., pressures less than about 20 bar or about 166 psi) while others (such as, e.g., spirally-wound high pressure filters, plate-and-frame units, disk-type filters) may be operated at higher pressures (i.e., about 20 bar (or about 332 psi) to about 300 bar (or about 4980 psi) or greater). For example, the silica precipitate-depleted fluid may be passed through the second filter device under pressures of about 5 bar (or about 83 psi) or less to about 70 bar (or about 1162 psi) or more, or about 100 bar (or about 1660 psi) or more. In one embodiment, the silica precipitate-depleted fluid is passed through a high-pressure reverse osmosis filter device, i.e., a reverse osmosis filter device which can be operated at pressures of about 100 bar (or about 1660 psi) to about 300 bar (or about 4980 psi) or greater. In another embodiment, the silica precipitate-depleted fluid is passed through a second filter device at a pressure in the range of about 100 bar (or about 1660 psi) or greater. In yet another embodiment, the silica precipitate-depleted fluid is passed through a disk-type reverse osmosis filter device.

The composition of the second concentrated brine may vary depending upon a variety of processing conditions, but the second concentrated brine will have a salt concentration that is, by a factor of greater than 1, greater than the salt concentration in the first concentrated brine. For example, the salt concentration of the second concentrated brine may be, e.g., at least about 1.3, or about 1.3 to about 15.0, or about 3.3 to about 10.0, or about 5.0 to about 8.0 times greater than the salt concentration of the first concentrated brine. In one embodiment, the salt concentration of the second concentrated brine is greater than about 2.4 times greater than the salt concentration of the first concentrated brine.

The second concentrated brine may be passed from the second filter device to one or more processing units (such as, e.g., an evaporator) for further processing. For example, particularly in a ZLD plant, the second concentrated brine may be passed from the second outlet of the second filter device to the inlet of an evaporator. Alternatively or additionally, permeate of the second filter device may be passed to one or more processing units (such as, e.g., reverse osmosis units) for further processing (such as, e.g., for reuse). In the illustrated embodiment of FIG. 2, the second concentrated brine is passed from the second filter device 160 to an evaporator (not shown) and permeate from the second filter device is passed to one or more reverse osmosis unit 170.

The process of the embodiment may be operated as continuous, semi-continuous, or batch mode. The process may also be modified to include multiple vessels and/or multiple stages of one or more aspects set forth herein to improve the treatment of the first concentrated brine. The present invention can be used anywhere within a wastewater treatment process.

Systems for treating concentrated brine in accordance with the invention may be configured in many ways. Some of the many different examples of a system for treating concentrated brine are shown in FIGS. 1 and 2. For example, in the embodiment illustrated in FIG. 1, the system 1 comprises a fluid input arrangement 2, a first filter device 4, and a second filter device 5. The fluid input arrangement 2 comprises one or more inlets, an outlet and an interior passageway. In the fluid input arrangement, the first concentrated brine containing silica and the one or more silica-precipitating agents are mixed in the interior passageway and a first fluid including a first concentrated brine and precipitates of silica is produced. The first fluid is be passed through the outlet of the fluid input arrangement 2 to first filter device 4, which is in fluid communication with the fluid input arrangement and, in one embodiment, includes a housing including an inlet, one or more outlets, one or more fluid flow paths defined between the inlet and outlet, and a microfiltration or ultrafiltration membrane positioned within the housing across the one or more fluid flow paths. Within the first filter device, according to this embodiment, as the first fluid passes through the membrane, precipitates of silica are retained by the membrane and a silica precipitate-depleted fluid passes through the membrane and through the one or more outlets to a second filter device 5, which is in fluid communication with first filter device 4 and includes, in at least one embodiment, a housing including an inlet, a first outlet and a second outlet, a first fluid flow path defined between the inlet and the first outlet, and a second fluid flow path defined between the inlet and the second outlet, and a reverse osmosis membrane having an upstream surface and downstream surface positioned within the housing across the first fluid flow path. Within the second filter device, according to this embodiment, the silica precipitate-depleted fluid is passed tangentially to the upstream surface of the membrane, a permeate is passed along the first flow path through the membrane and through the first outlet, and a second concentrated brine is passed tangentially to the upstream surface of the membrane and along the second flow path through the second outlet.

In another example, in the embodiment illustrated in FIG. 2, the system 100 comprises mixer 130, first filter device 150, and a second filter device 160. The mixer 130, according to one embodiment, includes one or more inlets for passing a first concentrated brine containing silica and one or more silica-precipitating agents into the mixer and an outlet. In the mixer, the first concentrated brine containing silica and the one or more silica-precipitating agents are mixed and a first fluid including a first concentrated brine and precipitates of silica is produced. The first fluid is passed through the outlet of the mixer 130 to the first filter device 150, which is in fluid communication with the mixer and, in one embodiment, includes a housing including an inlet, one or more outlets, one or more fluid flow paths defined between the inlet and the one or more outlets, and a microfiltration or ultrafiltration membrane positioned within the housing across the one or more fluid flow paths. Within the first filter device 150, according to this embodiment, as the first fluid passes through the membrane, precipitates of silica are retained by the membrane and a silica precipitate-depleted fluid passes through the membrane and through the one or more outlets to a second filter device 160, which is in fluid communication with first filter device 150, and includes, in at least one embodiment, a housing including an inlet, a first outlet and a second outlet, a first fluid flow path defined between the inlet and the first outlet, and a second fluid flow path defined between the inlet and the second outlet, and a reverse osmosis membrane having an upstream surface and downstream surface positioned within the housing across the first fluid flow path. Within the second filter device 160, according to this embodiment, the silica precipitate-depleted fluid is passed tangentially to the upstream surface of the membrane, a permeate is passed along the first flow path through the membrane and through the first outlet, and a second concentrated brine is passed tangentially to the upstream surface of the membrane and along the second flow path through the second outlet.

The components of the system may be arranged and configured in a variety of ways. For example, the fluid input arrangement may be configured in a variety of shapes and forms, including, e.g., a conduit, tube, pipe, or any other body having a passageway for passing a fluid therethrough, and may include additional components, such as, e.g., inlets, outlets, injection points, valves, etc. The fluid input arrangement may be arranged or positioned at various locations in the system, such as, e.g., downstream of the source of the first concentrated brine and upstream of, e.g., a mixer, a holding tank and/or a first filter device. Illustratively shown in FIG. 1, the fluid input arrangement 2 may be located upstream of the first filter device 4 and the second filter device 5. In one embodiment of the present invention, as shown in FIG. 2, the fluid input arrangement 120 is located downstream of a source of the first concentrated brine 110 and upstream of mixer 130, holding tank 140, first filter device 150, and second filter device 160. The fluid input arrangement may also be in direct or indirect fluid communication with one or more of the system components. For example, as illustratively shown in FIG. 1, the fluid input arrangement 2 is in direct fluid communication with the first filter device 4 and indirect fluid communication with the second filter device 5. Other components, such as, e.g., pumps, additional fluid lines, valves, etc. may also be in communication with the fluid input arrangement.

The fluid input arrangement may be positioned to receive the first concentrated brine containing silica and one or more silica precipitating agents from a source of the first concentrated brine. The fluid input arrangement may include one or more inlets that may be located at various locations on the fluid input arrangement. For example, in at least one embodiment, as shown in FIG. 1, the fluid input arrangement 2 may include an inlet 3 for injecting the one or more silica precipitating-agents into the fluid input arrangement. The first concentrated brine and the one or more silica precipitating-agents may be passed into the fluid input arrangement through common or separate inlets. The fluid input arrangement, in one embodiment, may also include an inlet 6 for passing a pH adjuster into the fluid input arrangement. Mixing the one or more silica-precipitating agents with the first concentrated brine (and, optionally, additional components, such as, e.g., a pH adjuster), under sufficient conditions, may induce the formation of silica precipitates in the first concentrated brine and help facilitate the removal of silica from the first concentrated brine.

One or more outlets may be located at various points on the fluid input arrangement. For example, the fluid input arrangement may include an outlet for passing a first fluid including a first concentrated brine and precipitates of silica from the fluid input arrangement to another downstream process, such as, e.g., a first filter device. In at least one embodiment, as shown in FIG. 1, the fluid input arrangement 2 includes an outlet for passing the first fluid into first filter device 4. In another embodiment, as shown in FIG. 2, the fluid input arrangement 120 includes an outlet for passing a mixture of a first concentrated brine containing silica and one or more silica-precipitating agents into a mixer 130. Other additives, such as, e.g., an agglomerating agent may also be introduced into the fluid input arrangement through one or more inlets.

In at least one other embodiment, the system includes a mixer. The mixer may be configured in many different ways. The mixer may be configured in any number of shapes or forms, including, e.g., an in-line mixer (such as, e.g., a static mixer) or a mixing container, one or more supported baffles, or a stirred cell device. The mixer may be arranged or positioned at a various locations in the system, such as, e.g., downstream of the source of the first concentrated brine and upstream of a holding tank and/or a first filter device. Illustratively, in one embodiment shown in FIG. 2, the mixer 130 is located downstream of the source of the first concentrated brine 110 and upstream of a holding tank 140, first filter device 150, and second filter device 160. The mixer may also fluidly communicate with one or more of the system components. For example, in one embodiment, as shown in FIG. 2, the mixer 130 is in direct fluid communication with at least one upstream component, such as, e.g., the source of the first concentrated brine 110 and holding tank 140, and in indirect fluid communication with one or more other downstream components, such as, e.g., first filter device 150, and second filter device 160.

The mixer may positioned or arranged in one or more of a variety of ways to receive the first concentrated brine comprising silica and one or more silica-precipitating agents, separately or in combination, from a source of the first concentrated brine. The mixer may include one or more inlets that may be located at various locations on the mixer. For example, in one embodiment, the mixer may include one or more inlets for passing a first concentrated brine comprising silica and one or more silica-precipitating agents into the mixer and an outlet. In other embodiments, the mixer may include an inlet for passing the first concentrated brine into the mixer and an inlet (e.g., a common or separate inlet) for directing one or more silica-precipitating agents into the mixer. In any one of the embodiments, the mixer may also include inlets for passing a pH adjuster into the mixer. Mixing the one or more compounds with the first concentrated brine comprising silica (and/or additional components, such as, e.g., a pH adjuster), under sufficient conditions, may induce the formation silica precipitates and help facilitate the removal of silica from the first concentrated brine.

One or more outlets may be located at various points on the mixer. In one embodiment, the mixer may include an outlet for passing a mixture of the first concentrated brine comprising silica and one or more silica-precipitating agents from the mixer to, e.g., another downstream component, such as, e.g., a holding tank. In another embodiment, the mixer may include an outlet for passing a first fluid including a first concentrated brine and precipitates of silica to, e.g., another downstream component, such as, e.g., a first filter device. Various other components may be associated with the mixer, including, e.g., a heater for adjusting the temperature within the mixer. Other additives, such as, e.g., an agglomerating agent may also be introduced into the mixer through one or more inlets.

In yet another embodiment, the system includes a holding tank. The holding tank may be configured in any number of ways. The holding tank may be configured in a variety of shapes and forms, including, e.g., a chamber, tube, receptacle, container, bag, etc. The holding tank, according to one embodiment, includes one or more holding tank inlets for passing, e.g., a mixture of the first concentrated brine and one or more silica-precipitating agents into the holding tank. In another embodiment, the holding tank includes one or more holding tank inlets for passing a first fluid including a first concentrated brine and precipitates of silica into the holding tank. The inlets may be located anywhere in relation to the holding tank, such as, e.g., top, bottom, or sides. In one embodiment, passing the mixture of the first concentrated brine and the one or more silica-precipitating agents (or, conversely, the first fluid) into the holding tank is through a single inlet. In another embodiment, the one or more silica-precipitating agents and the first concentrated brine are added separately into the holding tank. The first concentrated brine and one or more silica-precipitating agents, according to one embodiment, are mixed upstream of the holding tank and introduced into the holding tank through a single holding tank inlet. Various other components may be associated with the holding tank, including, e.g., a heater for adjusting the temperature within the holding tank. Other additives, such as, e.g., pH adjusters and/or additional compounds (such as, e.g., an agglomerating agent) may also be introduced into the holding tank through one or more holding tank inlets. The holding tank may be in fluid communication with the first filter device to pass the first fluid to the first filter device. In one embodiment, the holding tank includes one or more holding tank outlets for passing the first fluid from the holding tank to the first filter device via, e.g., a fluid input arrangement (and, in some examples, through a pump) for further processing.

The first and second filter devices may be arranged in many different structures, flow paths and formats, such as, e.g., a tank, vessel, container, tube, cylinder, single-stage, multi-staged, spiral, plate-and-frame, etc., and may include a variety of components (such as, e.g., one or more inlets, outlets and/or membranes) arranged in a variety of different configurations, such as, e.g., dead-end filtration arrangements, tangential flow filtration arrangements, or filtration arrangements wherein only a small portion of the fluid flow passes tangentially in the device.

For example, in one embodiment, the first filter device operates in a dead-end filtration arrangement, wherein the first filter device includes a housing having an inlet, an outlet, a fluid flow path defined between the inlet and the outlet, and a microfiltration or ultrafiltration membrane positioned within the housing across the fluid flow path. In another embodiment, the first filter device generally operates in a tangential flow filtration arrangement (or in a filtration arrangement wherein only a small portion of the fluid flow passes tangentially within the device), wherein the device includes a housing having an inlet, a first outlet, a second outlet, a first fluid flow path defined between the inlet and the first outlet, a second fluid flow path defined between the inlet and the second outlet, and a microfiltration or ultrafiltration membrane having an upstream and downstream surface positioned within the housing across the first fluid flow path.

In one embodiment, the second filter device operates in a tangential flow filtration arrangements, where a membrane is disposed in a housing comprising at least one inlet and at least two outlets and defining at least a first fluid flow path between the inlet and the first outlet, and a second fluid flow path between the inlet and the second outlet, wherein the membrane is positioned across the first fluid flow path, to provide the second filter device. In an illustrative embodiment, the second filter device can also include a second outlet, and defining a second fluid flow path between the inlet and the second outlet, the first outlet comprising a concentrate outlet, and the second outlet comprising a permeate outlet, wherein the membrane is disposed across the first fluid flow path.

The one or more membranes in the first and second filter devices may have a variety of different forms, such as, e.g., socks, pleated, hollow fibers, spiral shaped, cylindrical, capillaries, flat sheets, pillows, pouches, etc. For example, in one embodiment, the first filter device includes one or more microfiltration or ultrafiltration membranes in the form of hollow fibers. The hollow fibers may be arranged inside of a housing and/or may be potted or embedded into end pieces located at one or more ends of the hollow fibers. An exemplary first filter device, which can operate in either a dead-end or tangential flow arrangement, includes Pall Corporation Microza™ hollow fiber modules.

In one embodiment, the second filter device includes one or more reverse osmosis membranes that are spirally wound about a longitudinal axis (or a core or support tube). In another exemplary embodiment, the second filter device includes one or more reverse osmosis membranes in the form of flat sheets that are arranged in between one or more end pieces. In yet another exemplary embodiment, the second filter device includes one or more reverse osmosis membranes in the form of pillows or pouches.

The one or more membranes of the first and second filter devices may also include additional layers such as, e.g., feed layers, permeate layers, support and drainage layers, mesh or netting, etc. The filter devices may also include additional components, such as, e.g., end caps, end plates, sleeves, cages, cores, etc.

A variety of membranes may be used in the filter devices, including, e.g., permeable or porous metallic, ceramic, composite, or polymeric membranes. For example, in one embodiment, the reverse osmosis membrane in the second filter device is a polymeric reverse osmosis membrane. The membranes may have any variety of filtering characteristics. For example, in one embodiment, the first filter device includes one or more microfiltration membranes (i.e., membranes having a removal rating in the range from about 0.1 micron to about 1.0 microns) or one or more ultrafiltration membranes (i.e., membranes having a removal rating in the range of about 0.01 micron to about 0.1 micron). In one embodiment, the second filter device includes one or more reverse osmosis membranes having a salt rejection rating in the range of about 50% to about 99%. In another embodiment, the second filter includes a nanofiltration membrane. In yet another embodiment, the second filter includes a high-rejection seawater membrane.

The first filter device can be located at a variety of points in the system. For example, the first filter device may be, e.g., located downstream of a fluid input arrangement and/or mixer and upstream of the second filter device. The first filter device also be located downstream of a holding tank, if included in the system. The first filter device may be fluidly associated with one or more components of the system in a variety of ways. For example, in one embodiment, as illustrated in FIG. 1, the first filter device 4 is in fluid communication with fluid input arrangement 2. In another example of an embodiment, as shown in FIG. 2, the first filter device is in fluid communication with holding tank 140 (and/or the mixer 130 via the holding tank 140) and second filter device 160. In one embodiment, the one or more outlets of the mixer may be in fluid communication with the one or more inlets of the first filter device, such as, e.g., through a fluid input arrangement to pass a first fluid including a first concentrated brine and precipitates of silica into the first filter device. In the first filter device, according to this embodiment, as the first fluid passes through the membrane, the precipitates of silica are retained by the membrane and a silica precipitate-depleted fluid passes through the membrane and through the outlet.

In at least one embodiment, the silica precipitate-depleted fluid is passed from the first outlet of the first filter device to the second filter through device, e.g., a fluid input arrangement (and, in some examples, via a pump) for further processing.

The second filter device can be located at a variety of points in the system. For example, the second filter device may be, e.g., located downstream of the mixer and the first filter device and, in some cases, downstream of the holding tank. The second filter device may be in fluid communication with one or more of a variety of system components. For example, in one embodiment, the one or more outlets of the first filter device are in fluid communication with the one or more inlets of the second filter device, e.g., through a fluid input arrangement to pass the silica precipitate-depleted fluid to the second filter device for processing.

Within the second filter device 160, according to this embodiment, the silica precipitate-depleted fluid is passed tangentially to the upstream surface of the membrane, a permeate is passed along the first flow path through the membrane and through the first outlet, and a second concentrated brine is passed tangentially to the upstream surface of the membrane and along the second flow path through the second outlet.

In at least one embodiment, the second filter device may include an outlet for directing the second concentrated brine from the second filter device to one or more second concentrated brine processing units through, e.g., a fluid input arrangement (and in some examples, a pump) to further process the second concentrated brine. Additionally or alternatively, the second filter device may include an outlet for directing permeate from the second filter device to one or more permeate processing units through, e.g., a fluid input arrangement or recirculation line (and in some examples, a pump) to further process the permeate from the second filter device.

As described above, the recovery or production of the second concentrated brine may be limited by the osmotic pressure of the first concentrated brine. Therefore, as long as the second filter can withstand the higher pressures required to overcome the osmotic pressure of the first concentrated brine, any type of second filter device (e.g., spirally-wound low pressure, plate-and-frame, disk-type filters) may be used in accordance with one or more embodiments of the present invention. Exemplary second filter devices include, without limitation, spirally-wound low pressure reverse osmosis filters, plate-and-frame filters, and disk-type filters. In one embodiment, the second filter device is a high-pressure reverse osmosis filter device, i.e., a reverse osmosis filter device which can be operated at pressures of about 100 bar (or about 1660 psi) to about 300 bar (or about 4980 psi) or greater. In one illustrative embodiment, the second filter device is a disk-type filter device. Exemplary disk-type filter devices may include those described in greater detail in U.S. Pat. Nos. 4,892,657; 5,069,789; 5,183,567; 5,545,320; and 5,626,752, the entire disclosures of which are hereby incorporated by reference.

The processing units can be any type of device, system, unit, or mechanism for further processing the second concentrated brine from the second filter device. For example, the processing unit for the second concentrated brine may be, e.g., an evaporator, additional reverse osmosis units, such as, e.g., a high-pressure reverse osmosis unit, or any other means for further processing the second concentrated brine. In one embodiment, preferably in a ZLD plant, the processing unit is an evaporator. In some embodiments, permeate from the second filter device may also be passed to a processing unit, such as, e.g., a reverse osmosis unit, for further processing. In at least one embodiment, permeate from the second filter device may be recirculated or directed to the source of the first concentrated brine.

Although the invention has been disclosed in the embodiments previously described and/or illustrated, the invention is not limited to those embodiments. For example, one or more aspects or features of an embodiment may be eliminated, modified and/or combined with other aspects or features, without departing from the scope of the invention. For example, the holding tank may be eliminated from the system with the remainder of the system including previously described components. Other embodiments of the system may include other components (such as, e.g., pumps, fluid lines, valves, etc.) located in one or more locations within the system.

The present invention thus encompasses innumerable embodiments and is not restricted to the particular embodiments that have been described, illustrated, and/or suggested herein. Rather, the present invention includes all embodiments and modifications that may fall within the scope of the claims.

The following examples further illustrate the invention but, of course, should not be construed as in any way limiting its scope.

### Example 1

This example demonstrates the improvements in treating concentrated brine in accordance to an embodiment of the present invention.

Brine, including suspended solids, is pre-treated with a microfiltration device to remove the total suspended solids and to reduce the silt density index to less than 3 prior to processing in a reverse osmosis device (RO1). The brine has a total dissolved solids (TDS), which includes silica, magnesium, carbonate, calcium, sulfates, in the range of 5,000 to 20,000 mg/l. The brine is processed through a reverse osmosis device (RO1) and the concentrate from RO1 has a TDS in the range of 25,000 to 100,000 mg/l. Acid is injected into a fluid line containing the concentrate from RO1 to decrease the pH of the concentrate to about 7. 100 ppm of sodium aluminate is added to the fluid line and mixed thoroughly with the concentrate using a static mixer. The mixture is then held in a holding tank for a time period of about 10 minutes and precipitates of silica having a size of between 0.5 and 5 microns are formed.

The precipitates of silica and the concentrate are passed from the holding tank through a microfiltration device (having a membrane with an average pore size of 0.1 microns) and about 95% of the silica is removed, as a precipitate, from the concentrate. The concentrate that is depleted of the silica precipitates is processed through a Pall Disc-Tube RO (DTRO) reverse osmosis filter device, which will be able to operate at a higher pressure than the first reverse osmosis device (RO1), to form a concentrate and permeate. The concentration of the second concentrated brine has a TDS of about 150,000 mg/l.

### Example 2

This example demonstrates the degree of silica removal from a first concentrated brine in accordance with an embodiment of the present invention.

A pilot system is set up to test additional aspects of one or more embodiments of the present invention. Concentrated brine, including 160 ppm of silica and an initial conductivity of 994 uS/cm, is obtained from a reverse osmosis device and mixed with 20 ppm of sodium aluminate, at 100 rpm for 1 minute. The addition of the sodium aluminate increases the conductivity of the first concentrated brine to 1057 uS/cm. The mixture of the concentrated brine and the sodium aluminate is then held for times of 1 minute, 10 minutes, and 30 minutes and with differing amounts of silica-precipitates begin to form in the concentrated brine. The resulting concentrated brine containing the precipitates of silica is passed through flat sheet 0.45 micron PDVF microfiltration filter discs and the silica concentration in the filtrate is measured (see Table 1). Table 1 illustrates that the higher the silica concentration in the brine and the longer the holding times of the mixture of the first concentrated brine and sodium aluminate, the greater the silica removal by the microfiltration device.

TABLE 1

| | | 1 minute | 10 minute | 30 minute |
|---|---|---|---|---|
| Parameter | Unit | holding time | holding time | holding time |
| Holding Time | minutes | 1 | 10 | 30 |
| Silica Content in | ppm | 114 | 105 | 100 |
| Filtrate | | | | |
| % Silica | | 29% | 34% | 38% |
| Removed | | | | |

Experiments are also performed by varying the concentration of the sodium aluminate while keeping the other variables (such as, e.g., mixing rates, silica content, conductivity) constant. The mixture of sodium aluminate and the concentrate from RO1 is held for 5 minutes. Table 2 illustrates that the greater the amount of sodium aluminate mixed with the concentrated brine, the greater the silica removal by the microfiltration device.

TABLE 2

| Parameter | Unit | | | | |
|---|---|---|---|---|---|
| Sodium | ppm | 20.2 | 50.1 | 69.7 | 101 |
| Aluminate | | | | | |
| Dosage | | | | | |
| Silica | ppm | 90 | 45 | 15 | 8 |
| Content in | | | | | |
| Filtrate | | | | | |
| % Silica | | 40% | 70% | 90% | 95% |
| Removed | | | | | |

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A process for treating concentrated brine, comprising:
a. mixing a first concentrated brine, comprising silica, with one or more silica-precipitating agents and producing a first fluid comprising a first concentrated brine and precipitates of silica;
b. passing the first fluid through the inlet of a first filter device comprising a housing comprising an inlet, one or more outlets, one or more fluid flow paths defined between the inlet and the one or more outlets, a microfiltration or ultrafiltration membrane positioned within the housing across the one or more fluid flow paths; passing the first fluid through the membrane; retaining the precipitates of silica by the membrane and passing a silica precipitate-depleted fluid which passes through the membrane through the one or more outlets;
c. passing the silica precipitate-depleted fluid through the inlet of a second filter device comprising a housing comprising an inlet, a first outlet and a second outlet, a first fluid flow path defined between the inlet and first outlet, and a second fluid flow path defined between the inlet and the second outlet, a reverse osmosis membrane having an upstream surface and a downstream surface positioned within the housing across the first fluid flow path; passing the silica precipitate-depleted fluid tangentially to the upstream surface of the membrane; passing a permeate along the first fluid flow path through the membrane and through the first outlet, and passing a second concentrated brine tangentially to the upstream surface of the membrane and through the second outlet.

2. The process according to claim 1, further comprising holding the mixture of (a) prior to producing a first fluid.

3. The process according to claim 2, wherein holding the mixture of (a) comprises holding the mixture for between at least about 1 minute and about 30 minutes.

4. The process according to claim 1, wherein the first concentrated brine is mixed with about 5 ppm to about 300 ppm of the one or more silica-precipitating agents.

5. The process according to claim 2, wherein the first concentrated brine is mixed with about 70 ppm to about 100 ppm of the one or more silica-precipitating agents.

6. The process according to claim 1, wherein the first concentrated brine is mixed with one silica-precipitating agent to produce a first fluid comprising a first concentrated brine and precipitates of silica, and another silica-precipitating agent to produce agglomerates of the precipitates of silica.

7. The process according to claim 1, further comprising adjusting the pH of the first concentrated brine prior to (a).

8. The process according to claim 1, wherein passing through a second filter device in (c) includes passing the silica precipitate-depleted fluid through a high-pressure reverse osmosis filter device.

9. The process according to claim 1, wherein passing through a second filter device in (c) includes passing the silica precipitate-depleted fluid through a disk-type filter device.

10. The process according to claim 1, wherein passing through a second filter device in (c) includes passing the silica precipitate-depleted fluid through a second filter device under a pressure of about 100 bar or greater.

11. A system for treating concentrated brine, comprising:
a. a mixer comprising one or more inlets for passing a first concentrated brine comprising silica and one or more silica-precipitating agents into the mixer, and an outlet;
b. a first filter device in fluid communication with the mixer, wherein the first filter device includes a housing comprising an inlet, one or more outlets, one or more fluid flow paths defined between the inlet and the one or more outlets, and a microfiltration or ultrafiltration membrane located within the housing across the one or more fluid flow paths; and
c. a second filter device in fluid communication with the first filter device, wherein the second filter device includes a housing comprising an inlet, a first outlet and a second outlet, a first fluid flow path defined between the inlet and the first outlet, and a second fluid flow path defined between the inlet and the second outlet, a reverse osmosis membrane having an upstream surface and a downstream surface positioned within the housing across the first fluid flow path.

12. The system of claim 11, further comprising a holding tank having a holding tank inlet in fluid communication with the outlet of the mixer and a holding tank outlet in fluid communication with the inlet of the first filter device.

13. The system of claim 11, wherein the second filter device is a high-pressure reverse osmosis filter device.

14. The system of claim 11, wherein the second filter device is a disk-type filter device.

15. A system for treating concentrated brine, comprising:
a. a fluid input arrangement comprising one or more inlets, an outlet and an interior passageway;
b. a first filter device in fluid communication with the fluid input arrangement, wherein the first filter device includes a housing comprising an inlet, one or more outlets, one or more fluid flow paths defined between the inlet and the one or more outlets, and a microfiltration or ultrafiltration membrane located within the housing across the one or more fluid flow paths; and
c. a second filter device in fluid communication with the first filter device, wherein the second filter device includes a housing comprising an inlet, a first outlet and a second outlet, a first fluid flow path defined between the inlet and the first outlet, and a second fluid flow path defined between the inlet and the second outlet, a reverse osmosis membrane having an upstream surface and a downstream surface positioned within the housing across the first fluid flow path.

16. The system of claim 15, further comprising a holding tank having a holding tank inlet in fluid communication with the fluid input arrangement and a holding tank outlet in fluid communication with the inlet of the first filter device.

17. The system of claim 15, wherein the second filter device is a high-pressure reverse osmosis filter device.

18. The system of claim 15, wherein the second filter device is a disk-type filter device.

19. The A ZLD plant comprising a system according to claim 11 and an evaporator.

20. The process according to claim 3, wherein passing through a second filter device in (c) includes passing the silica precipitate-depleted fluid through a second filter device under a pressure of about 100 bar or greater.
